(19) United States
(12) Patent Application Publication
(10) Pub. No.: US 2019/0012690 A1
(43) Pub. Date: Jan. 10, 2019

(54) SYSTEM AND METHOD FOR TRACKING AUDIOVISUAL CONTENT USE

(71) Applicant: Sony Mobile Communications Inc., Tokyo (JP)

(72) Inventor: Ola THORN, Limhamn (SE)

(21) Appl. No.: 16/067,610

(22) PCT Filed: Feb. 17, 2016
(86) PCT No.: PCT/US2016/018156

§ 371 Date: Jul. 1, 2018

(51) Int. Cl. G06Q 30/02

(52) U.S. Cl. CPC G06Q 30/0224; G06Q 30/0272

(57) ABSTRACT

Tracking user consumption of audiovisual content includes outputting the audiovisual content for consumption by the user and identifying that a target component of the audiovisual content has been consumed by the user. A code associated with the target component is acquired or enabled, the identifying that the target component of the audiovisual content has been consumed is a trigger to perform at least one of the acquiring or enabling of the code associated with the target component. When the code is used, use of the code is communicated to a server as feedback that use of the code was made.

### TECHNICAL FIELD OF THE INVENTION

The technology of the present disclosure relates generally to electronic devices and, more particularly, to a system and method for tracking use of audiovisual content and tracking user actions taken subsequent to consumption of audiovisual content.

### BACKGROUND

A popular activity is to receive and consume audiovisual content using an electronic device, such as a mobile telephone, tablet computer, or other type of device. Example forms of audiovisual content that may be acquired and consumed in this manner include audio files, audio podcasts, audio books, streaming audio, video files, video podcasts, streaming video, video games, and an electronic book or an electronic magazine.

To some extent, audiovisual content may be customized for a user. For instance, an audio advertisement may be inserted into an audio podcast where the audio advertisement is selected based on prior knowledge about the user. In this manner, the advertising may be considered to be tailored to the user. Regardless of whether an advertisement has been tailored to the user or is a generic advertisement, it is very difficult to determine if the user acts upon the advertisement.

In other situations, a user may be required to complete the consumption of audiovisual content to receive credit, such as credit toward the completion of an educational course, continuing legal education credit, and so forth. Confirming that the user has completed the consumption of the audiovisual content also may be difficult.

### SUMMARY

According to one aspect of the disclosure, disclosed is a method of tracking user consumption of audiovisual content. The method includes outputting the audiovisual content for consumption by the user; identifying that a target component of the audiovisual content has been consumed by the user; acquiring or enabling a code associated with the target component, wherein the identifying that the target component of the audiovisual content has been consumed is a trigger to perform at least one of the acquiring or enabling of the code associated with the target component; using the code; and communicating the use of the code to a server as feedback that use of the code was made.

According to one embodiment of the method, the code is not in an audio format or in a video format.

According to one embodiment of the method, the code is in a machine-readable format, an alphanumeric character string, a uniform resource locator, or an NFC coupon.

According to one embodiment of the method, the audiovisual content is an audio podcast.

According to one embodiment of the method, the identifying includes determining that the outputting of the audiovisual content has reached a predetermined point in the audiovisual content.

According to one embodiment of the method, the identifying includes matching speech in the audiovisual content to a predetermined word or phrase.

According to one embodiment of the method, the matching includes converting the speech of the audiovisual content to text.

According to one embodiment of the method, the acquiring the code includes requesting the code from the server.

According to one embodiment of the method, the code is obtained contemporaneously with obtaining the audiovisual content and is included in a file or data stream used to transfer the audiovisual content to an electronic device operated by the user.

According to another aspect of the disclosure, an electronic device is configured to track user consumption of audiovisual content. The electronic device includes a memory that stores the audiovisual content; an output component through which the audiovisual content is output for consumption by the user; and a control circuit configured to identify that a target component of the audiovisual content has been consumed by the user; acquire or enable a code associated with the target component, wherein the identifying that the target component of the audiovisual content has been consumed is a trigger to at least one of acquire or enable the code associated with the target component; use the code; and communicate the use of the code to a server as feedback that use of the code was made.

According to an embodiment of the electronic device, the code is not in an audio format or in a video format.

According to an embodiment of the electronic device, the code is in a machine-readable format, an alphanumeric character string, a uniform resource locator, or an NFC coupon.

According to an embodiment of the electronic device, the audiovisual content is an audio podcast.

According to an embodiment of the electronic device, the identifying includes determining that the output of the audiovisual content has reached a predetermined point in the audiovisual content.

According to an embodiment of the electronic device, the identifying includes matching speech in the audiovisual content to a predetermined word or phrase.

According to an embodiment of the electronic device, the matching includes converting the speech of the audiovisual content to text.

According to an embodiment of the electronic device, the acquiring the code includes requesting the code from the server.

According to an embodiment of the electronic device, the code is obtained contemporaneously with obtaining the audiovisual content and is included in a file or data stream used to transfer the audiovisual content to the electronic device.

According to another aspect of the disclosure, a method of associating a code with audio visual content includes converting audio of the audiovisual content to text; identifying target audio content in the audiovisual content by identifying a predetermined word or phrase in the converted text; and associating the code with the target content.

According to one embodiment of the method, the code is associated at a point in the audiovisual content at which the target audio content is present.

### BRIEF DESCRIPTION OF THE DRAWINGS

FIG. 1 is a schematic block diagram of an operational environment for an electronic device.

FIG. 2 is a flow-diagram of an audiovisual content consumption operation carried out by the electronic device.

FIG. 3 is a flow-diagram of an audiovisual content tagging function.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### Introduction

Described below in conjunction with the appended figures are various embodiments of systems and methods for tracking use of audio content and actions taken subsequent to listening to audio content. The disclosed techniques are primarily described in the context of an audio podcast received and consumed by a portable electronic device, such as a smart phone or a tablet computer. But the techniques may be applied in other contexts, such as other types of audiovisual content and/or other types of electronic devices, such as computers, gaming consoles, media players, etc.

### System Architecture

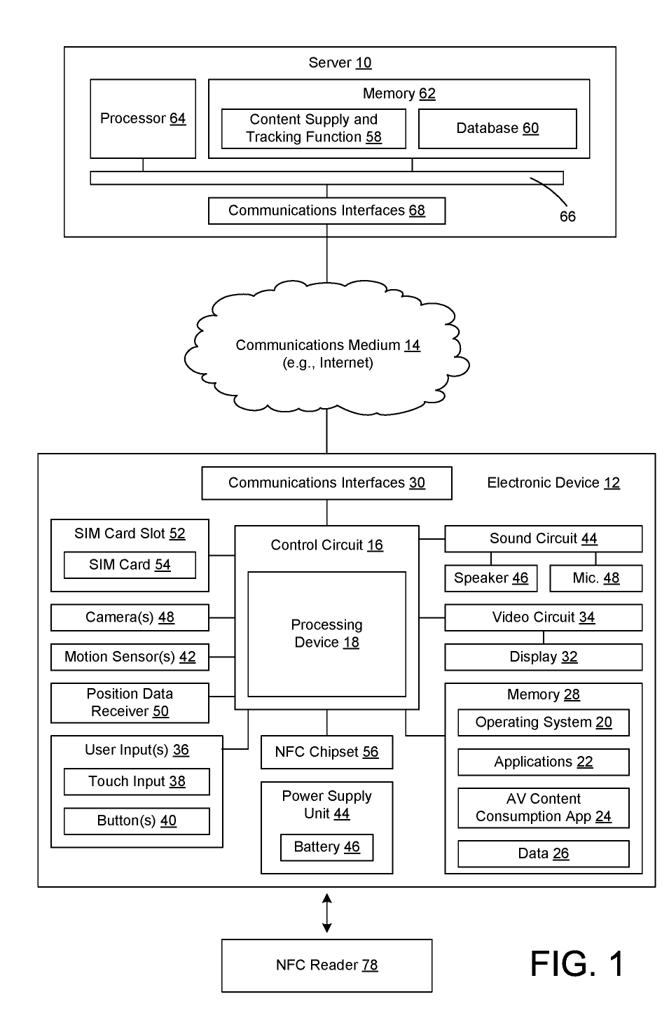

FIG. 1 is a schematic diagram of an exemplary system for implementing the disclosed techniques. It will be appreciated that the illustrated system is representative and other systems may be used to implement the disclosed techniques. Also, functions disclosed as being carried out by a single device, such as the disclosed server, may be carried out in a distributed manner across nodes of a computing environment.

The system includes a server 10 that may be in operative communication with an electronic device 12 (also referred to as a user equipment or UE). The server 10 also may be in operative communication with other devices operated by the same user as the electronic device 12 and/or may be may be in operative communication with other devices that are operated by other users or that are deployed by other parties. The electronic device 12 may be one of a variety of types of devices, such as a mobile phone, a tablet computer, a laptop computer, a desktop computer, a gaming device, a media player, etc. As will be described, the server 10 and the electronic device 12 are configured to carry out the respective logical functions that are described herein.

The server 10 communicates with the electronic device 12 over any appropriate communications medium 14, such as one or more of the Internet, a cellular or subscriber network, a WiFi network, etc. In addition to carrying out the operations described herein, the server 10 may carry out other support and service operations for the electronic device 12.

In its exemplary embodiment as a mobile telephone, the electronic device 12 includes a control circuit 16 that is responsible for overall operation of the electronic device 12, including controlling the electronic device 12 to carry out the operations described in greater detail below. The control circuit 16 includes a processor 18 that executes an operating system 20 and various applications 22. The functions described as being carried out by the electronic device 12 may be embodied as part of the operating system 20 or in an application 22. In the illustrated embodiment, these functions may be embodied as a dedicated application, such as an audiovisual (AV) content consumption application 24.

The operating system 20, the applications 22, 24, and stored data 26 (e.g., data associated with the operating system 20, the applications 22, 24, audiovisual files and user files), are stored on a memory 28. The operating system 20 and applications 22, 24 are embodied in the form of executable logic routines (e.g., lines of code, software programs, etc.) that are stored on a non-transitory computer readable medium (e.g., the memory 28) of the electronic device 12 and are executed by the control circuit 16. The functions described herein may be thought of as methods that are carried out by the electronic device 12.

The processor 18 of the control circuit 16 may be a central processing unit (CPU), microcontroller, or microprocessor. The processor 18 executes code stored in a memory (not shown) within the control circuit 16 and/or in a separate memory, such as the memory 28, in order to carry out operation of the electronic device 12. The memory 28 may be, for example, one or more of a buffer, a flash memory, a hard drive, a removable media, a volatile memory, a non-volatile memory, a random access memory (RAM), or other suitable device. In a typical arrangement, the memory 28 includes a non-volatile memory for long term data storage and a volatile memory that functions as system memory for the control circuit 16. The memory 28 may exchange data with the control circuit 16 over a data bus. Accompanying control lines and an address bus between the memory 28 and the control circuit 16 also may be present. The memory 28 is considered a non-transitory computer readable medium.

The electronic device 12 includes communications interfaces 30 that enable the electronic device 12 to establish various wireless communication connections. In the exemplary embodiment, the communications interfaces include one or more radio circuits (e.g., modems). Each radio circuit may include a radio frequency transceiver and an antenna assembly (or assemblies). In one embodiment, the electronic device 12 is a multi-mode device capable of communicating using more than one standard and/or over more than one radio frequency band. Therefore, in addition to the presence of one or more than one radio transceiver and one or more than one antenna, present are any appropriate tuner, impedance matching circuits, and other components needed for the various supported frequency bands and radio access technologies. Exemplary network access technologies supported by the communications interfaces 30 include cellular circuit-switched network technologies and packet-switched network technologies (e.g., WiFi). The communications interfaces 30 may further represent any radio transceivers and antennas used for local wireless communications directly with another electronic device, such as over a Bluetooth interface.

The electronic device 12 may include a display 32 for displaying information and video content to a user. The display 32 may be coupled to the control circuit 16 by a video circuit 34 that converts video data to a video signal used to drive the display 32. The video circuit 34 may include any appropriate buffers, decoders, video data processors and so forth.

The electronic device 12 may include one or more user inputs 36 for receiving user input for controlling operation of the electronic device 12. Exemplary user inputs 36 include, but are not limited to, a touch sensitive input 38 that overlays or is part of the display 32 for touch screen functionality, and one or more buttons 40. Other types of data inputs may be present, such as one or more motion sensors 42 (e.g., gyro sensor(s), accelerometer(s), etc.).

The electronic device 12 may further include a sound circuit 44 for processing audio signals. Coupled to the sound circuit 44 are a speaker 46 and a microphone 48 that enable audio operations that are carried out with the electronic device 12 (e.g., conduct telephone calls, output sound, capture audio, etc.). The sound circuit 44 may include any appropriate buffers, encoders, decoders, amplifiers and so forth. Audio may be output in other manners, such as via a wired or wireless accessory that is coupled to the electronic device 12.

The electronic device 12 may further include a power supply unit 44 that includes a rechargeable battery 46. The power supply unit 44 supplies operating power from the battery 46 to the various components of the electronic device 12 in the absence a connection from the electronic device 12 to an external power source.

The electronic device 12 also may include various other components. For instance, the electronic device 12 may include one or more input/output (I/O) connectors (not shown) in the form electrical connectors for operatively connecting to another device (e.g., a computer) or an accessory (e.g., earphones) via a cable, or for receiving power from an external power supply.

Another exemplary component may be one or more cameras 48 for taking photographs or video, or for use in video telephony. As another example, a position data receiver 50, such as a global positioning system (GPS) receiver, may be present to assist in determining the location of the electronic device 12. The electronic device 12 also may include a subscriber identity module (SIM) card slot 52 in which a SIM card 54 is received. The slot 52 includes any appropriate connectors and interface hardware to establish an operative connection between the electronic device 12 and the SIM card 54.

Another exemplary component may be a near field communication (NFC) chipset 56 that allows the electronic device 12 to interface and communicate with another NFC-enabled device using an NFC protocol.

The server 10 may be implemented as a computer-based system that is capable of executing computer applications (e.g., software programs), including a content supply and tracking function 58 that, when executed, carries out functions of the server 10 that are described herein. The content supply and tracking function 58 and a database 60 may be stored on a non-transitory computer readable medium, such as a memory 62. The database 60 may be used to store various information sets used to carry out the functions described in this disclosure. The memory 62 may be a magnetic, optical or electronic storage device (e.g., hard disk, optical disk, flash memory, etc.), and may comprise several devices, including volatile and non-volatile memory components. Accordingly, the memory 62 may include, for example, random access memory (RAM) for acting as system memory, read-only memory (ROM), solid-state drives, hard disks, optical disks (e.g., CDs and DVDs), flash devices and/or other memory components, plus associated drives, players and/or readers for the memory devices.

To execute logical operations, the server 10 may include one or more processors 64 used to execute instructions that carry out logic routines. The processor 64 and the memory 62 may be coupled using a local interface 66. The local interface 66 may be, for example, a data bus with accompanying control bus, a network, or other subsystem.

The server 10 may have various input/output (I/O) interfaces for operatively connecting to various peripheral devices, as well as one or more communications interfaces 68. The communications interface 68 may include for example, a modem and/or a network interface card. The communications interface 68 may enable the server 10 to send and receive data signals to and from other computing devices via an external network. In particular, the communications interface 68 may operatively connect the server 10 to one or more external communications mediums, including establishing operative connection to the Internet.

The server 10 may communicate with other server systems, such as server systems that track user consumption of audiovisual content and/or sources or audiovisual content.

### Content Consumption Tracking

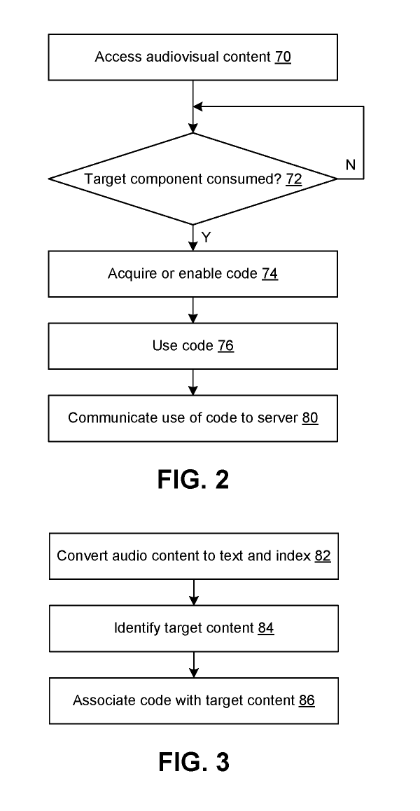

With additional reference to FIG. 2, shown is an exemplary flow diagram representing steps that may be carried out by the electronic device 12 when executing logical instructions to carry out the audiovisual content consumption application 24. Also understood from this disclosure will be complimentary operations of the server 10 (e.g., as embodied in the content supply and tracking function 58) and/or complimentary operations of other devices (e.g., sources of audiovisual content different than the server 10, terminals with which the electronic device 12 communicates, etc.). Although illustrated in a logical progression, the illustrated blocks of FIG. 2 may be carried out in other orders and/or with concurrence between two or more blocks. Therefore, the illustrated flow diagram may be altered (including omitting steps) and/or may be implemented in an object-oriented manner or in a state-oriented manner.

In block 70, the user may control the electronic device 12 to access audiovisual content. In an exemplary embodiment, the audiovisual content is an audio podcast that has been previously downloaded to the electronic device 12. As indicated, operations described herein may be used in conjunction with other types of audiovisual content, such as audio files, streaming audio, audio books, video podcasts or files, streaming video, games, electronic books and electronic magazines. A file containing the audiovisual content may be downloaded from the server 10 or data containing the audiovisual content may be streamed to the electronic device 12 from the server 10.

Accessing the audiovisual content in block 70 includes consuming the audiovisual content, such as playing audio through speakers or earphones to the user. In the case of video content, the consumption of the content may include displaying a video component on a display and outputting an audio component through speakers or earphones to the user.

In block 72, a determination is made as to whether consumption of the audiovisual content includes consumption of a target component of the audiovisual content. The target component is a portion of the audiovisual content for which there is a desire to track user consumption or a desire to track actions of the user following consumption of the audiovisual content. By way of example, if credit is to be attributed to the user for consuming the content (e.g., course credit in an academic or training context), then the target component may be an entire audio file that contains the audiovisual content accessed in block 70. As another example, if an advertiser is interested in data relating to consumer response to advertisements, then the target component may be an advertisement that is incorporated into the audiovisual content. The advertisement may be positioned at any point in the audiovisual content, such as a beginning of the content, a predetermined amount of time into the audiovisual content or at the end of the end of the audiovisual content.

A positive determination may be made in block 72 in manner appropriate for the format of the audiovisual content and the nature of the target component. In one embodiment, detection of consumption of the target component may be determined by reaching a predetermined position in the audiovisual content. The predetermined position may be indicated by metadata associated with the audiovisual content or may be known to the audiovisual content consumption application 24 by communicating with the server 10 or by using a default value. The predetermined position may be specified in an appropriate manner, such as an amount of time into the content, the start or the end of a chapter, with a bookmark, or in some other identifiable manner.

In another embodiment, detection of consumption of the target component may be determined by converting speech in the audiovisual content to text and then identifying an occurrence of a predetermined keyword or phrase in the converted text. The predetermined keyword or phrase may be indicated by metadata associated with the audiovisual content or may be known to the audiovisual content consumption application 24 by communicating with the server 10.

In an embodiment where the content is consumed by reading, such as is found with electronic books and electronic magazines, eye gaze tracking of the user may be used in conjunction with tracking the displayed content to determine that the user has reached a predetermined location in the content.

In one embodiment, if the user skips the target component (e.g., by jumping ahead in the audiovisual content) or fast-forwarding through the target component, then a negative determination is made in block 72.

If a negative determination is made in block 72, the consumption of the content may continue. If a positive determination is made in block 72, the logical flow may proceed to block 74. In the case where the target component is positioned before the end of the audiovisual content, the audiovisual content may continue to play even though a positive determination is made in block 72.

In block 74, a code is acquired and/or enabled by the electronic device 12. For example, the electronic device may request the code from the server 10 and the server 10 may transmit a message with the code to the electronic device 12. Alternatively, the code may have already been acquired by the electronic device 12. For instance, the code may be transmitted with the audiovisual content in metadata or embedded with the audiovisual content or the code may be transmitted in a message to the electronic device 12 in a message prior to a positive determination in block 72. In cases where the code is acquired by the electronic device 12 prior to a positive determination in block 72, the code may be enabled (e.g., unlocked) in block 74.

In one embodiment, the code is not in an audio format or in a video format. Accordingly, the code is not part of the audiovisual content that is consumed even if the code forms part of the file or data stream that is used to deliver the audiovisual content to the electronic device 12. The server 10 may generate the code, embed the code with a file or a data stream containing the audiovisual content, and/or transmit the code to the electronic device 12 separately from the file or data stream containing the audiovisual content. The code may be in a machine-readable format, may be alphanumeric character string (e.g., text), may be a linkable uniform resource locator (URL), may be in the form of an NFC coupon, or may take on some other form.

In one embodiment, the code is unique for the user of the electronic device 12. A unique code may be of assistance in validating consumption of the audiovisual content by the user or in limiting use of the code to one occurrence. Alternatively, the code may be the same for multiple instances of the audiovisual content. In this case, the electronic devices of multiple users may receive the same code.

Enabling the code in block 74 allows the user of the electronic device 12 to make use of the code in block 76. The manner in which the code is used may depend on the nature of the audiovisual content and the reason for supplying to the code to the electronic device 12. In one embodiment, the code is displayed to the user and the user may enter the code into another application (e.g., an Internet browser, a media player application, a game, etc.) or into another device or system to validate that the user has consumed the audio visual content. Other uses of the code may be made, such as entering the code to unlock or acquire other audiovisual content, entering the code when making a purchase from a website to receive a discount, etc. In another embodiment, the code is displayed as a link to a website that the user may select to browse to the website using an Internet browser.

In one embodiment, the code need not be displayed or made known to the user. Rather, the audiovisual content consumption application 24 may enter the code into another application (e.g., an Internet browser, a media player application, a game, etc.), a website or another device or system to make use of the code.

In another embodiment, the code is used by transmitting the code to another device such as, but not limited to, a merchandizing terminal or point of sale system (e.g., a cash register). In this embodiment, the code may be in the form of an NFC coupon or any other appropriate form as previously described. As shown in FIG. 1, the other device may include an NFC reader 78 (FIG. 1). The electronic device 12 may be brought into close proximity with the NFC reader 78 so that the NFC chipset 56 engages in operative communication with the NFC reader 78 and transfers the code to the NFC reader 78. In this embodiment, the electronic device 12 and the NFC reader 78 are physically present with one another (e.g., within a few meters of one another). Other ways to transfer the code from the electronic device 12 to another device that is located in close proximity with the electronic device 12 are possible, such as by using communication using radio frequency identification (RFID) technology, a Bluetooth interface, a WiFi interface, a cable, an electrical connector, displaying the code (or associated bar code) and optically scanning the code, infrared data transmission, outputting a visible or non-visible light patterns, outputting an audible or non-audible audio signal, etc.

Next, in block 80, use of the code may be communicated to the server 10. In one embodiment, the electronic device 12 communicates use of the code to the server 10. In other embodiments, use of the code is communicated by another device or system that receives the code from the electronic device 12.

Blocks 72, 74, 76 and 80, or portions thereof, may be executed automatically by the electronic device 12 (e.g., without user involvement) and/or may be executed transparently to the user (e.g., without user knowledge that the operations occur).

The server 12 may track the codes that are used and the associated electronic device users. The users may be identified in a number of manners. In one embodiment, the audiovisual content consumption application 24 is registered with the server 10 in a manner that enables identification of the user when use of a code is reported to the server 10 by the audiovisual content consumption application 24. In another embodiment, the use of the code may be communicated with other identifying information that may be used by the server to identify the user such as, but not limited to, a user name, an ID used for a popular Internet service such as FACEBOOK, a phone number, an email address, etc.

Tracking use of the codes may be used for various functions. For example, use of a code may allow the server 10 to allocate credit to the user for consumption of the content. In another example, the use of the code may be logged in a database used by an advertiser to improve the delivery of custom or targeted advertisements to the user. The use of the code may be further used to track success of an advertising campaign to the specific user and/or across a number of users of electronic devices. Also, the data may be used for an advertiser to make payment to a content provider (e.g., podcaster) based on successful user response to an advertisement.

With additional reference to FIG. 3, shown is an exemplary flow diagram representing steps that may be carried out by the server 10 when executing logical instructions to carry out one embodiment of a code association operation of the content supply and tracking function 58. Other embodiments of associating a code with audiovisual content are possible, such as associating a code with a predetermined location in the audiovisual content. Although illustrated in a logical progression, the illustrated blocks of FIG. 3 may be carried out in other orders and/or with concurrence between two or more blocks. Therefore, the illustrated flow diagram may be altered (including omitting steps) and/or may be implemented in an object-oriented manner or in a state-oriented manner.

In some instances, it may be desirable to associate a code with a specific audio component of audiovisual content. For some audio content, the point at which the specific audio component may be known and the server 10 may make the association from this information.

In other instances, the point at which the specific audio component occurs is unknown. Also unknown may be whether the specific audio component is present in the audiovisual content. These situations may arise, for example, in podcasts related to live events or unscripted content. The embodiment of FIG. 3 addresses these situations by converting the audio content to text in block 82. The text may be indexed for searching and data management purposes.

Next, in block 84, the specific audio component of interest (e.g., target content) is identified, if present in the audiovisual content. The specific audio content may be the mention of a predetermined keyword or a predetermined phrase. The predetermined keyword or predetermined phrase may be the same keyword or phrase for which monitoring is made in the speech to text embodiment of block 72 mentioned above. If the specific audio content is identified in block 84, the logical flow may proceed to block 86 where the code is associated with the position of the specific audio content in the audiovisual file for later use in connection with the carrying out of the steps described in connection with FIG. 2.

### Example

A number of example situations in which the disclosed techniques may be applied have been described. The following is an explanation of another example. In this example, a podcast containing audio content is downloaded to an electronic device 12 and played to a user through speakers or earphones. Within the podcast is an audio advertisement that promotes a discount at a merchant and contains instructions to redeem the discount. For instance, a speaker may state the name of the merchant, the amount of the discount and the manner in which the code associated with the advertisement from the podcast may be used. In an embodiment where the code is in the form of an NFC coupon for ten percent off a purchase at a coffee house named Sam's Coffee Stand, the advertisement could state “receive ten percent off a coffee drink at Sam's Coffee Stand by tapping your mobile device at checkout.” When the advertisement is played, the NFC coupon may be activated (enabled) in the user's electronic device. The user may then purchase a drink in accordance with the advertised special and, when paying, tap the electronic device to an NFC reader at the establishment. The NFC reader will receive the NFC coupon so that the discount may be applied to the purchase price of the drink. The electronic device communicates use of the NFC coupon to the server 10, which may log that the coupon was redeemed by the user. In the case where the redeemed code is valid for only one purchase, the code may be retired so that it cannot be redeemed again.

### CONCLUSION

Although certain embodiments have been shown and described, it is understood that equivalents and modifications falling within the scope of the appended claims will occur to others who are skilled in the art upon the reading and understanding of this specification.

1. A method of tracking user consumption of audiovisual content and subsequent action taken by the user with an electronic device, comprising:
outputting the audiovisual content for consumption by the user;
identifying that a target component of the audiovisual content has been output to the user by determining that the outputting of the audiovisual content has reached a predetermined point in the audiovisual content;
acquiring or enabling a code associated with the target component, wherein the code is unique for the user of the electronic device and wherein the identifying that the target component of the audiovisual content has been reached during the outputting is a trigger to automatically perform at least one of the acquiring or enabling of the code associated with the target component;
using the code, use of the code limited to one occurrence; and
automatically communicating the use of the code to a server as feedback that use of the code was made.

2. The method of claim 1, wherein the code is not in an audio format or in a video format.

3. The method of claim 2, wherein the code is in a machine-readable format, an alphanumeric character string, a uniform resource locator, or an NFC coupon.

4. The method of claim 1, wherein the audiovisual content is an audio podcast.

5-7. (canceled)

8. The method of claim 1, wherein the acquiring the code includes requesting the code from the server.

9. The method of claim 1, wherein the code is obtained contemporaneously with obtaining the audiovisual content and is included in a file or data stream used to transfer the audiovisual content to an electronic device operated by the user.

10. An electronic device configured to track user consumption of audiovisual content and subsequent action taken by the user, comprising:
a memory that stores the audiovisual content;
an output component through which the audiovisual content is output for consumption by the user; and
a control circuit configured to:
identify that a target component of the audiovisual content has been output to the user by determining that the outputting of the audiovisual content has reached a predetermined point in the audiovisual content;
acquire or enable a code associated with the target component, wherein the code is unique for the user of the electronic device and wherein the identifying that the target component of the audiovisual content has been reached during the outputting a trigger to automatically perform at least one of acquire or enable the code associated with the target component;
use the code, use of the code limited to one occurrence; and
automatically communicate the use of the code to a server as feedback that use of the code was made.

11. The electronic device of claim 10, wherein the code is not in an audio format or in a video format.

12. The electronic device of claim 11, wherein the code is in a machine-readable format, an alphanumeric character string, a uniform resource locator, or an NFC coupon.

13. The electronic device of claim 10, wherein the audiovisual content is an audio podcast.

14-16. (canceled)

17. The electronic device of claim 10, wherein the acquiring the code includes requesting the code from the server.

18. The electronic device of claim 10, wherein the code is obtained contemporaneously with obtaining the audiovisual content and is included in a file or data stream used to transfer the audiovisual content to the electronic device.

19-20. (canceled)
